(19) United States
(12) Patent Application Publication
(10) Pub. No.: US 2016/0253087 A1
(43) Pub. Date: Sep. 1, 2016

(54) APPARATUS AND METHOD FOR CONTROLLING CONTENT BY USING LINE INTERACTION

(71) Applicant: SAMSUNG ELECTRONICS CO., LTD., Suwon-si (KR)

(72) Inventors: Joo-sun MOON, Seoul (KR); Pill-kyoung MOON, Anyang-si (KR); Se-ran JUN, Seongnam-si (KR); Ji-min HONG, Seoul (KR); Jae-Yeop KIM, Seoul (KR); Kwan-min LEE, Seoul (KR); Jean-christophe NAOUR, Anyang-si (KR); Joon-ho PHANG, Seoul (KR); Ha-yeon YOO, Seongnam-si (KR)

(73) Assignee: Samsung Electronics Co., Ltd., Suwon-si (KR)

(21) Appl. No.: 14/908,303

(22) PCT Filed: Aug. 10, 2015
(86) PCT No.: PCT/KR2015/008343

§ 371 Date: Jan. 28, 2016

(30) Foreign Application Priority Data
Aug. 8, 2014 (KR) 10-2014-0102620

(51) Int. Cl. G06F 3/0488; G06F 3/16; G09G 5/30; H04N 5/57; G11B 27/02; H04N 9/793; H04N 9/802; G06F 3/0484; G11B 27/00

(52) U.S. Cl. CPC G06F 3/04883; G06F 3/04847; G06F 3/165; G09G 5/30; G06F 3/167; G06F 3/04845; G06F 3/04842; G11B 27/005; G11B 27/02; H04N 9/793; H04N 9/802; H04N 5/57; G09G 2320/0626; G09G 2320/0666; G06F 2203/04806; G06F 2203/04808

(57) ABSTRACT

A method of controlling content by using line interaction includes displaying a play bar region, representing a reproduction state of the content, on a touch screen, displaying an object, representing a function associated with reproduction of the content, near a reproduction time of the reproduction bar region, receiving a user input with respect to the play bar region through the touch screen, determining control information about the content, based on the received user input, and controlling the content according to the determined control information.

### CROSS-REFERENCE TO RELATED APPLICATIONS

This application is a U.S. national stage application of International Application No. PCT/KR2015/008343 filed Aug. 10, 2015, and claims the priority benefit of Korean Application No. 10-2014-0102620, filed Aug. 8, 2014, in the Korean Intellectual Property Office, the disclosures of which are incorporated herein by reference.

### BACKGROUND

1. Field

The following description relates to an apparatus and method for controlling content by using line interaction, and more particularly, to an apparatus and method for controlling content according to a user input with respect to a play bar region displayed by a touch screen device.

2. Description of the Related Art

User interfaces (UIs) denote apparatuses or software which may enable a user to easily use digital devices. Recently, smart functions such as the Internet browsers, games, social networking service applications, and/or the like or other complex functions are installed in digital devices such as blue-ray players, multimedia players, set-top boxes, and/or the like, and thus, it is required to enable a UI, which is used to manipulate a digital device, to receive various types of inputs. Therefore, graphic UIs (GUIs) are being used for quickly and intuitively transferring information to a user. A user using a device such as a keypad, a keyboard, a mouse, a touch screen, or the like may move a pointer displayed on a GUI to select an object with the pointer, thereby commanding a digital device to perform a desired operation.

In reproducing content by a touch screen device, a play bar representing a reproduction state is displayed on a touch screen and represents a relative position of a current reproduction time relative to a total reproduction length of the content. Because the play bar is displayed on the touch screen, a user may adjust the play bar to adjust a reproduction time of the content. A play bar of the related art is displayed to represent time-based information of content. When the user selects a desired reproduction time from the play bar, a portion of the content corresponding to the selected reproduction time may be adjusted to be reproduced.

### SUMMARY

The following description relates to a user interface (UI) providing method and apparatus that enable a user to easily control content displayed by a touch screen device by reflecting an interaction aspect of the user of the touch screen device.

Additional aspects will be set forth in part in the description which follows and, in part, will be apparent from the description, or may be learned by practice of the presented exemplary embodiments.

According to an aspect of an exemplary embodiment, a content control method performed by a touch screen device includes: displaying a play bar region, representing a reproduction state of the content, on a touch screen; displaying an object, representing a function associated with reproduction of the content, near a reproduction time of the reproduction bar region; receiving a user input with respect to the play bar region through the touch screen; determining control information about the content, based on the received user input; and controlling the content according to the determined control information.

The function associated with reproduction of the content may include one or more selected from whether to reproduce the content, a reproduction speed, and an additional reproduction function.

The additional reproduction function may include a screen brightness adjustment function, a sound adjustment function, and a chroma adjustment function for the content.

The control information about the content may include one selected from control information about reproduction of the content and control information about editing of the content.

The object representing a function associated with reproduction of the content may include one selected from a text object and an image object.

The displaying of the object may include displaying the object when at least one input selected from a touch input of a user, a proximity touch input, and a voice input is received by the touch screen device.

The determining of the control information may include, when the user input received through the play bar region is a touch input with respect to a partial region of the play bar region corresponding to a current reproduction time of the content, determining control information for playing or pausing the content.

The determining of the control information may include, when the user input received through the play bar region is a touch input with respect to a partial region of the play bar region which does not correspond to a current reproduction time of the content, determining control information for displaying a portion of the content, corresponding to a reproduction time which corresponds to a partial region of the play bar region where the touch input is received, on the touch screen.

The determining of the control information may include, when the user input received through the play bar region is a pinch to zoom input, determining control information that allows the play bar region for a reproduction section of the content, corresponding to the pinch to zoom input, to be enlarged and displayed and allows the content to be reproduced at a reproduction speed corresponding to an enlargement rate of the pinch to zoom.

The determining of the control information may include, when the user input received through the play bar region is a touch input which is made by touching a predetermined region for a predetermined time or more, determining control information that allows an object, representing information about editing of the content, to be displayed.

The content control method may further include: receiving a user input for selecting an editing target section of the content through the play bar region; and receiving a user input with respect to the editing target section of the content.

The receiving of the user input with respect to the editing target section may include: receiving an input which is made by dragging a partial region of the play bar region, corresponding to the editing target section, in a first direction; and extracting, as separate content, a portion of the content corresponding to the editing target section, based on the first-direction drag input.

The receiving of the user input with respect to the editing target section may include: receiving an input which is made by dragging a partial region of the play bar region, corresponding to the editing target section, in a second direction; and deleting the editing target section from the content, based on the second-direction drag input.

According to an aspect of an exemplary embodiment, a touch screen device for controlling content includes: a display unit that displays a play bar region, representing a reproduction state of the content, on a touch screen and displays an object, representing a function associated with reproduction of the content, near a reproduction time of the reproduction bar region; an input unit that receives a user input with respect to the play bar region; and a control unit that determines control information about the content, based on the user input received by the input unit and controls the content according to the determined control information.

According to an aspect of an exemplary embodiment, provided is a non-transitory computer-readable storage medium storing a program for executing the content control method performed by the touch screen device.

According to an aspect of an exemplary embodiment, provides is a computer program stored in a recording medium for executing a method in connection with hardware, the method including: displaying a play bar region, representing a reproduction state of the content, on a touch screen; displaying an object, representing a function associated with reproduction of the content, near a reproduction time of the reproduction bar region; receiving a user input with respect to the play bar region through the touch screen; determining control information about the content, based on the received user input; and controlling the content according to the determined control information.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a content reproduction screen of the related art;

FIG. 2 is a block diagram illustrating a touch screen device according to an exemplary embodiment;

FIG. 3 illustrates a screen displayed on a touch screen according to an exemplary embodiment;

FIG. 4 is a diagram illustrating an operation of controlling, by a touch screen device, content according to an exemplary embodiment;

FIG. 5 illustrates a play bar region according to an exemplary embodiment;

FIG. 6 is a diagram illustrating an operation of determining, as control information, a user input with respect to a play bar region according to an exemplary embodiment;

FIG. 7 illustrates a play bar region according to an exemplary embodiment;

FIG. 8 illustrates a play bar region according to an exemplary embodiment;

FIG. 9 illustrates a play bar region according to an exemplary embodiment;

FIG. 10 illustrates an editing screen of content according to an exemplary embodiment;

FIG. 11 illustrates an editing screen of content according to an exemplary embodiment;

FIG. 12 illustrates a screen for controlling content by using a remote control apparatus according to an exemplary embodiment;

FIG. 13 illustrates a remote control apparatus according to an exemplary embodiment;

FIG. 14 is a diagram illustrating an operation of controlling content by using a remote control apparatus according to an exemplary embodiment; and

FIG. 15 is a block diagram illustrating a remote control apparatus according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present inventive concept. As used herein, the term “and/or” includes any and all combinations of one or more of the associated listed items. Expressions such as “at least one of,” when preceding a list of elements, modify the entire list of elements and do not modify the individual elements of the list.

Hereinafter, exemplary embodiments will be described in detail with reference to the accompanying drawings. In the drawings, like reference numerals refer to like elements, and the size and thickness of each element may be exaggerated for clarity and convenience of description.

In this disclosure, a touch input denotes a touch gesture of a manipulation device applied to a touch screen for inputting a control command to a touch screen device. For example, examples of the touch input described herein may include a tap, a touch and hold, a double tap, a drag, panning, a flick, a drag and drop, etc., but are not limited thereto.

In the present specification, a button input denotes an input that controls the touch screen device by a user using a physical button attached to the touch screen device or the manipulation device.

Moreover, an air input denotes an input that is applied by a user in the air above a surface of a screen so as to control the touch screen device. For example, the air input may include an input that presses an auxiliary button of a manipulation device or moves the manipulation device without the user contacting a surface of the touch screen device. The touch screen device may sense a predetermined air input by using a magnetic sensor.

Moreover, an object may be a still image, a moving image, or a text representing predetermined information and may be displayed on a screen of the touch screen device. The object may include, for example, a user interface (UI), an execution result of an application, an execution result of content, a list of pieces of content, and an icon of content, but is not limited thereto.

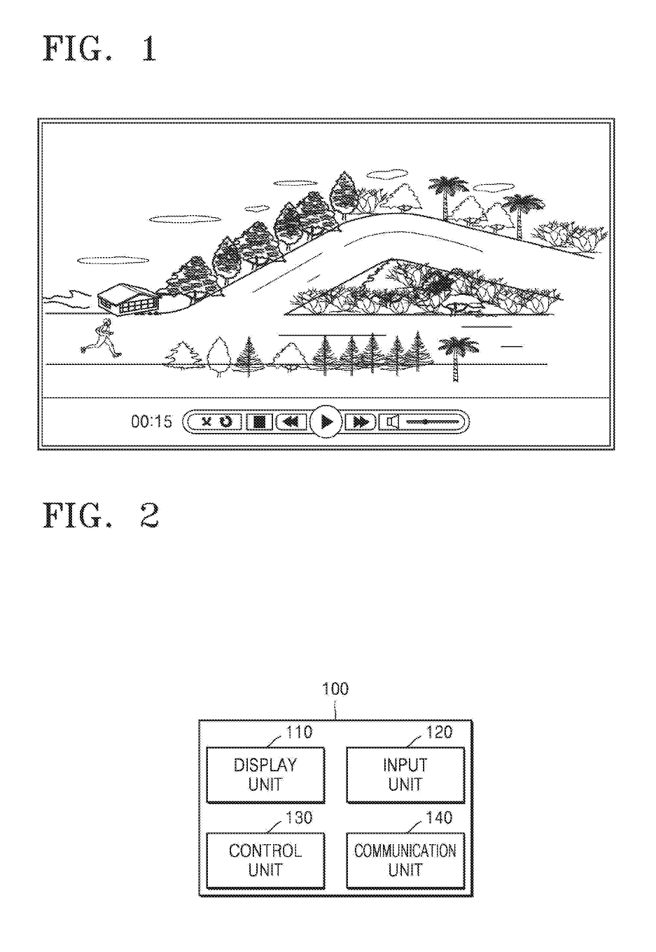

FIG. 1 illustrates a content reproduction screen of the related art.

When a display apparatus reproduces content including information about a predetermined time, like video or music, the display apparatus may display a play bar for informing a user of information about a current reproduction time. A play bar for reproducing content, such as a video or image slides, may be generally displayed as a straight line, and a reproduction time of the content may be moved by moving the play bar from the left to the right (or from the right to the left). When a display apparatus receives an input, which selects a reproduction time desired by a user, from the user and again receives an input that issues a command to reproduce the content, consistent control of the content is not supported with respect to a play bar and content reproduction.

Hereinafter, a method of providing a consistent interaction with respect to a play bar and content control by providing a function associated with a current reproduction state of content at a current reproduction time in a line interaction-enabled play bar region will be described in detail.

FIG. 2 is a block diagram illustrating a touch screen device 100 according to an exemplary embodiment.

The touch screen device 100 may include a display unit 110, an input unit 120 that receives external data, a control unit 130 that processes input data, and a communication unit 140 that communicates with other devices. The touch screen device 100 may be a smart television (TV) that includes a built-in operating system (OS) and accesses the Internet as well as public TV networks and cable TV networks or executes various applications. Because the smart TV is a TV that is implemented by equipping a digital TV with an OS and an Internet access function, and the smart TV may receive real-time broadcasts and may use various content, such as video on demand (VOD), games, search, mergence, an intelligent service, and/or the like, in a convenient user environment. Also, the touch screen device 100 may be a device where the display unit 110 is built into or provided outside equipment such as blue ray players, multimedia players, set-top boxes, personal computers (PCs), game consoles, and/or the like. Furthermore, a device for providing a graphic UI (GUI) may be used as the touch screen device 100.

The display unit 110 may include an image panel such as a liquid crystal panel, an organic light-emitting panel, or the like and may display graphics of a UI which represents a function setting, a software application, or content (hereinafter referred to as a manipulation menu) such as music, a photograph, video, and/or the like.

The input unit 120 is an interface that receives data such as content or the like displayed by the display unit 110 and may include at least one selected from a universal serial bus (USB), parallel advanced technology attachment (PATA), serial advanced technology attachment (SATA), flash media, Ethernet, Wi-Fi, and Bluetooth.

Depending on the case, the touch screen device 100 may include an information storage device (not shown) such as an optical disk drive, a hard disk, and/or the like and may receive data through the information storage device.

Moreover, the input unit 120 may be a touch screen where a touch panel and an image panel have a layer structure. The touch panel may be, for example, a capacitive touch panel, a resistive touch panel, an infrared touch panel, or the like. The image panel may be, for example, a liquid crystal panel, an organic light-emitting panel, or the like. Such a touch panel is well known, and thus, a detailed description of a panel structure will not be provided. The image panel may display graphics of a UI.

The control unit 130 may decode data which is input through the input unit 120.

The control unit 130 may provide a UI, based on an OS of the touch screen device 100. The UI may be an interface in which a use aspect of a user is reflected. For example, the UI may be a GUI where pieces of content are separately displayed in order for a user to simply and easily manipulate and select content with the user sitting on a sofa in a living room, or may be a GUI that enables a letter to be input by displaying a web browser or a letter input window capable of being manipulated by a user.

The communication unit 140 may transmit or receive a control command to or from another device. The communication unit 140 may use a well-known communication module such as an infrared communication module, a radio communication module, an optical communication module, and/or the like. For example, the infrared communication module satisfying an infrared data association (IrDA) protocol that is an infrared communication standard may be used as the communication unit 140. As another example, a communication module using a frequency of 2.4 GHz or a communication module using Bluetooth may be used as the communication unit 140.

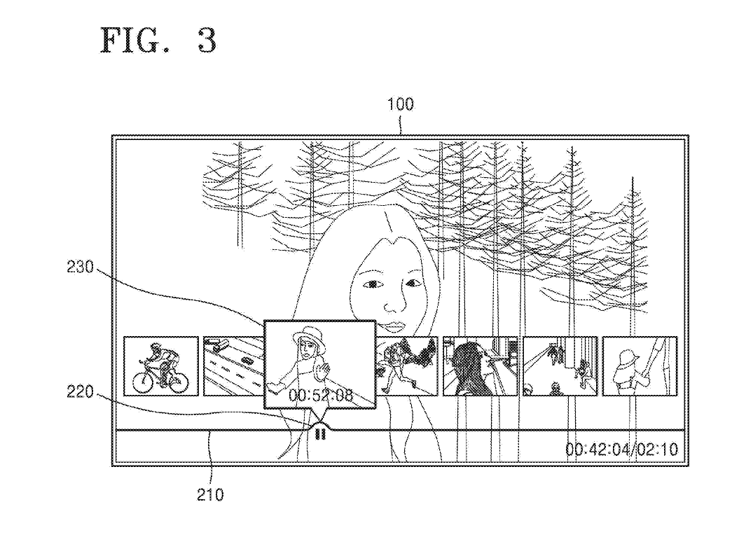

FIG. 3 illustrates a screen displayed on a touch screen according to an exemplary embodiment.

As illustrated in FIG. 3, a play bar 210 may be displayed in the display unit 110 of the touch screen device 100. Also, an object 220 representing a current reproduction time may be displayed. Also, a thumbnail image 230 for a corresponding reproduction time may be displayed along with the object 220.

In the disclosure, a play bar may not just denote one time line displayed on a touch screen but may be construed as including regions which are disposed near the time line and enable an input for controlling the play bar to be received from a user. Thus, in the disclosure, a play bar and a play bar region may be interchangeably used, and as described above, the play bar may be understood as a region for receiving a user input with respect to the play bar.

Generally, the play bar 210 may be arranged on a lower portion, an upper portion, or a side of the touch screen so as not to distract a user from content which is being displayed on the touch screen that is the display unit 110. In the drawing, it may be seen that the play bar 210 is displayed in the form of a rectilinear bar on the lower portion of the touch screen. The play bar 210 may be displayed as a straight line on the touch screen, and a length from one end to the other end may correspond to a total reproduction time of content. For example, when video content of a two-hour length is executed through a program called a windows media player and is displayed in the display unit 110, the play bar 210 displayed by the display unit 110 may represent a total video length and may also represent time information of a reproduction time when content is currently reproduced. When a part of current video content corresponding to a time when 30 minutes elapses from a beginning reproduction time is being reproduced, “0:30:00/2:00:00” may be displayed near a time line of the play bar 210. Because reproduction of content based on a time is displayed, control consistent with a time line which is displayed as a straight line in the display unit 100 may be performed.

As illustrated in FIG. 3, the touch screen device 100 may display a current reproduction state of the content according to a touch input of the user with respect to the play bar 210 region. For example, in a case where a total reproduction time of reproduced video is 1:33:36, when a convex portion such as a ridge is displayed on a left ⅓ position of the time line of the reproduction bar 210, a reproduction section corresponding to approximately 0:31:12 may be displayed as being currently reproduced.

Current reproduction time information of the content may be displayed, and information “0:31:12” may be displayed in the form of text in the display unit 110 of the touch screen device 100, for providing more accurate information to the user. In the present disclosure, a portion representing a current reproduction time in the play bar 210 may be convexly displayed like a ridge and thus may be referred to as a ridge bar.

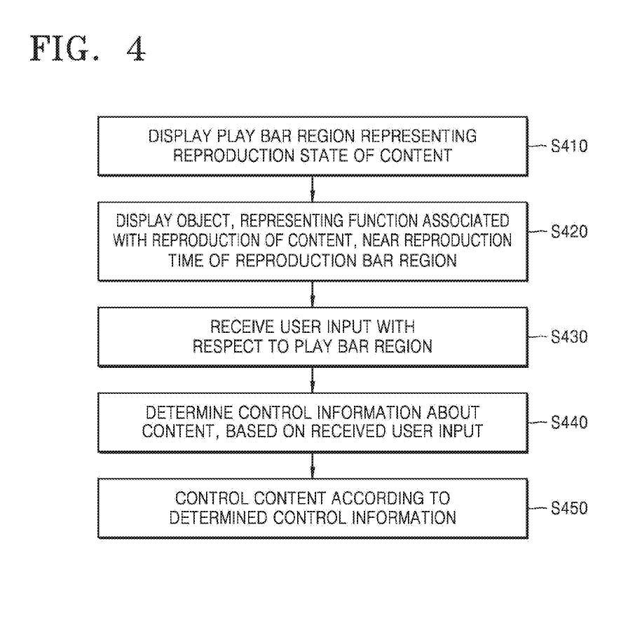

FIG. 4 is a diagram illustrating an operation of controlling, by a touch screen device, content according to an exemplary embodiment.

In operation S410, the display unit 110 of the touch screen device 100 may display the play bar 210 region representing a reproduction state of content. The play bar 210 region may not be displayed while the content is being reproduced, and when the reproduction of the content is stopped or a user input for the content is received, the display unit 100 may display the play bar 210 region on the touch screen. A detailed example of displaying the play bar 210 region on the touch screen will be described below.

In operation S420, the display unit 110 of the touch screen device 100 may display an object, representing a function associated with the reproduction of the content, near a reproduction time of the play bar 210 region. The function associated with the reproduction of the content may be a function for whether to play or pause the content, or may be a function for a reproduction speed for whether to increase or lower a reproduction speed. In addition to a time-based function of content, an additional reproduction function may include, for example, a screen brightness adjustment function, a sound adjustment function, a resolution adjustment function, and a chroma adjustment function with respect to the content. The additional reproduction function may denote a function of separately controlling each of pieces of content, and thus may be distinguished from a screen brightness adjustment function, a sound adjustment function, a resolution adjustment function, and a chroma adjustment function of the touch screen device 100 itself.

In operation S430, the touch screen device 100 may receive a user input with respect to the displayed play bar 210 region. The user input may be a touch input that is made by directly touching the play bar 210 region of the touch screen, or may be a pen input made using a stylus pen. Also, a proximity sensor may be built into the touch screen, and thus, the touch screen device 100 may receive a proximity touch of the user.

The user input may be an input of a command for controlling the content, and the command for controlling the content may be divided into a control command for the reproduction of the content and a control command for editing the content.

In operation S440, the control unit 130 of the touch screen device 100 may determine control information about the content, based on the received user input. The control unit 130 may determine the user input as control information about reproduction or control information about editing according to a predefined reference.

In operation S450, the control unit 130 of the touch screen device 100 may determine a function which is to be executed with respect to the content, based on the determined control information, and control the content. The control unit 130 may perform control of reproduction by stopping content which is being reproduced, changing a reproduction speed, and/or the like. The control unit 130 may perform control with respect to editing that extracts some time sections of content as separate content or deletes some time sections of the content.

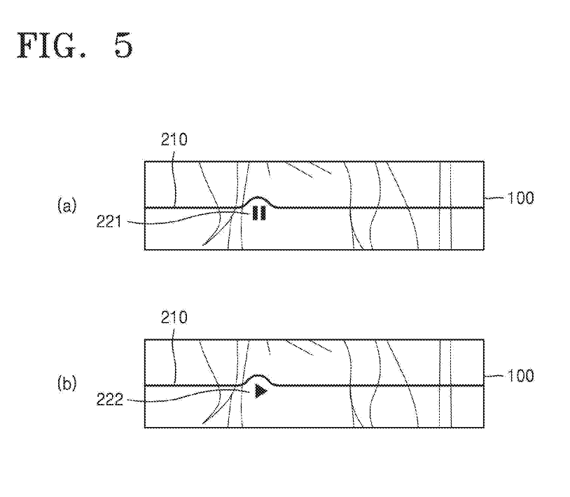

FIG. 5 illustrates a play bar region according to an exemplary embodiment.

FIG. 5 part (a) illustrates a screen where a play bar 210 region is displayed on the touch screen when content is being reproduced, and FIG. 5 part (b) illustrates a screen where the play bar 210 region is displayed on the touch screen when content is stopped.

When content is being reproduced by the touch screen bar 100, the play bar 210 region may not be displayed. The play bar 210 region may not be displayed so as not to distract a user watching the content.

A case of displaying the play bar 210 region on the touch screen will now be described. While the content is being displayed on the touch screen, the touch screen device 100 may receive a user input from the user. When the user input is received, the control unit 130 of the touch screen device 100 may prepare for receiving control information about the displayed content. Therefore, the play bar 210 region may be displayed on the touch screen, and the control unit 130 enables the user to easily input a content control input by providing the user with information which represents a control function for controlling the content.

A user input that allows the play bar 210 region to be displayed on the touch screen may be a touch input, a proximity touch input, a pen touch input, or a voice input. When the touch input is received through the touch screen or a grip input by gripping the touch screen device 100 is received, the play bar 210 region may be displayed on the touch screen. Also, the touch screen device 100 may receive a voice command of the user to display the play bar 210 region, and for example, when the user inputs a predefined command such as “play bar” or “control”, the touch screen device 100 may display the play bar 210 region, based on a predefined voice command.

The touch screen device 100 may convexly display a current reproduction time of the play bar 210 region like a ridge. The user may recognize a portion which is convexly displayed like a ridge, and thus may determine a current reproduction progress of the content.

As illustrated in FIG. 5 parts (a) and (b), an image object 221 or 222 representing a pause/play function may be displayed near a reproduction time of the play bar 210 region. When the content is being currently reproduced, the object 221 representing the pause function for stopping reproduction may be displayed, and when the content is stopped, an object 222 representing a play function for initiating the reproduction of the content may be displayed.

An object representing a function associated with reproduction of content may be an image object or may be a text object expressed as a text. For example, like “play” or “pause”, a function directly controlled by a user may be displayed near the reproduction time of the play bar 210 region.

A related art method of displaying a play object or a pause object on a fixed position of a touch screen has a problem in that a user input is not intuitively made, but is made for a fixed position. On the other hand, in the present disclosure, as described above, an intuitive and easy control environment is provided to a user by displaying a content control-related function near a reproduction time of the play bar 210 region.

When a user input received through the play bar 210 region is a touch input corresponding to the current reproduction time of the content, the control unit 130 of the touch screen device 100 may reproduce or stop the content. While the content is being reproduced, when a touch input for the pause object 221 displayed near the current reproduction time is received from the user, the control unit 130 of the touch screen device 100 may determine the received touch input as control information for stopping the reproduction of the content which is being currently reproduced. Therefore, the control unit 130 may stop the reproduction of the content according to the determined control information. While the content is stopped without being reproduced, when a touch input for the play object 222 displayed near the current reproduction time is received from the user, the control unit 130 of the touch screen device 100 may determine the received touch input as control information for initiating the re-production of the content which is being currently reproduced. Therefore, the control unit 130 may initiate the reproduction of the content according to the determined control information.

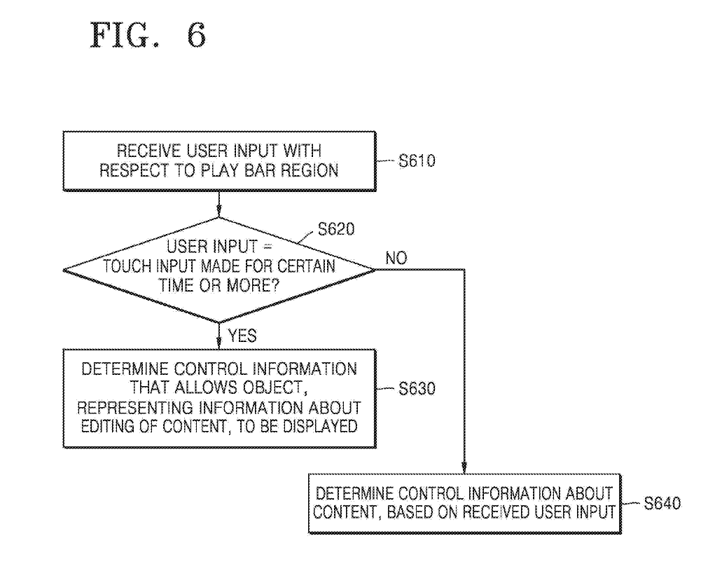

FIG. 6 is a diagram illustrating an operation of determining, as control information, a user input with respect to a play bar 210 region according to an exemplary embodiment.

In operation S610, the input unit 120 of the touch screen device 100 may receive a user input with respect to the play bar 210. The play bar 210 region may be being displayed on the touch screen, and a touch input with respect to the play bar 210 region may be received from a user.

In operation S620, the control unit 130 of the touch screen device 100 may determine whether a user input is a touch input which is made for a predetermined time or more. That is, the control unit 130 may determine whether the user input is a long press input, thereby determining how the user input with respect to the play bar 210 region will control the content.

In operation S630, when it is determined that the user input is a touch input (i.e., the long press input) which is made for a predetermined time or more, the control unit 130 may determine the user input as control information that allows an object, representing information about editing of the content, to be displayed. An object representing that the content is able to be edited may be displayed to the user, and for example, an X-shaped text object may be displayed as an object, indicating that the content is able to be edited, in the play bar 210 region. Alternatively, a thumbnail image object for a reproduction time may be displayed on the touch screen to be shaken. Subsequently, the control unit 130 may receive a user input for editing the content to edit the content.

In operation S640, when it is determined that the user input is not the touch input which is made for a predetermined time or more, the control unit 130 of the touch screen device 100 may determine control information about the content, based on the received user input. Subsequently, the control unit 130 may perform control for the reproduction of the content, based on the determined control information.

Hereinafter, an operation of determining control information about reproduction of content and control information about editing of the content to control the content will be described in detail.

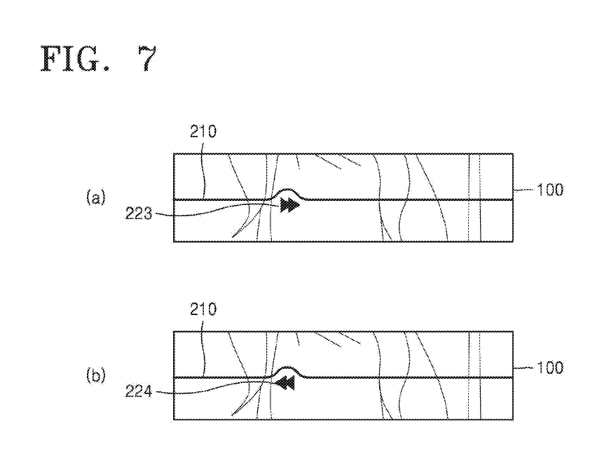

FIG. 7 illustrates a play bar 210 region according to an exemplary embodiment.

FIG. 7 part (a) illustrates an object 223 representing a forward function as a function associated with reproduction of content in the play bar 210 region, and FIG. 7 part (b) illustrates an object 224 representing a rewind function. As described above with reference to FIGS. 5 part (a) and 5 part (b), when the play bar 210 region is displayed on the touch screen, a user input may be received. When a left-to-right drag (or swipe) input of a user is received through the play bar 210 region while an object representing a play function or a pause function is displayed in the play bar 210 region, the control unit 130 of the touch screen device 100 may determine that the received drag input is not control information representing the play function or the pause function.

When a user input received through the play bar 210 region is a touch input which does not correspond to a current reproduction time of content, the control unit 130 of the touch screen device 100 may move a reproduction time of the content to a reproduction time where the drag input ends. When the user input is a drag input that moves by a predetermined length in a state of contacting the play bar 210 region, the touch screen device 100 may display the forward object 223 or the reward object 224 in response to movement of a reproduction time while a touch input of a predetermined length is being received.

The touch screen device 100 may display a thumbnail image of a reproduction time corresponding to the drag input in the play bar 210 region in response to the drag input of the user. This is because a more accurate reproduction time adjustment environment is provided in a case where an object representing a function is displayed along with a thumbnail image, than a case of displaying only the object representing the function.

As described above, the control unit 130 may receive, from the user, a touch input of the play bar 210 region corresponding to a reproduction time instead of a current reproduction time of the content to move a reproduction time of the content.

To provide a detailed description on the reproduction time movement of the play bar 210 region, the user may select a desired reproduction time by touching the play bar 210 region on the touch screen or by dragging (or swiping) the play bar 210 region to the left or right. In this case, the control unit 130 of the touch screen device 100 may make a total length of the play bar 210 correspond to a total reproduction time of the content. For example, it is assumed that the play bar 210 is 10 cm in a smartphone that is a type of touch screen device 100 and a total reproduction time of the content is 1:33:36, and when a touch input for a center (5 cm region) position of the play bar 210 is received from the user, the control unit 130 may map the total length of the play bar 210 with a reproduction time of the content by selecting a time “0:46:48” which is half the total reproduction time of the content. Such a method is a method that enables a user to intuitively select a reproduction time of content.

However, the present exemplary embodiment is not limited to a case of mapping the total length of the play bar 210 with the total reproduction time of the content. If the content is divided into a plurality of time sections, the total length of the play bar 210 may be mapped with one time section of the content. For example, in video content where a total time of a soccer game is recorded, mapping all time sections (about two hours) of first half and second half with the total length of the play bar 210 may be a general method of controlling the play bar 210, but a time section (about one hour) corresponding to the first half may be mapped with the total length of the play bar 210.

A case opposite to this may be implemented. For example, in video content where only first half in a total time of a soccer game is recorded, a touch input of the user may be received through only a left 5 cm section of the play bar 210 region. By emphatically displaying the play bar 210 region in only the left 5 cm section, the user recognizes that the content cannot be controlled in a right 5 cm section of the play bar 210 region, and recognizes that the video content displayed on the touch screen of the touch screen device 100 corresponds to a portion of total video content.

As an example, a user may know that movie content data of a three-hour length is downloaded, but when data of final thirty-minute duration is not downloaded, by deactivating a final ⅙ portion of the play bar 210 region, the touch screen device 100 may inform the user that content of final thirty-minute duration is not reproduced.

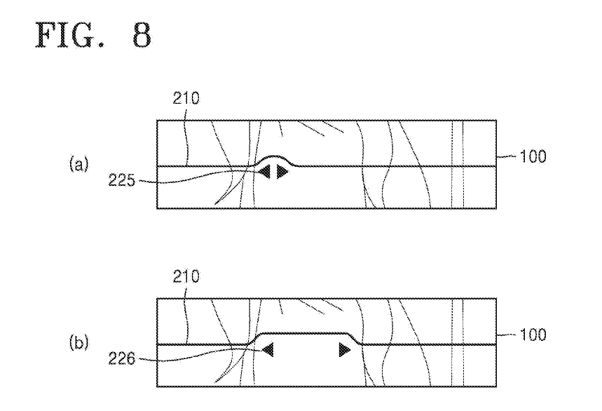

FIG. 8 illustrates a play bar 210 region according to an exemplary embodiment.

Because a physical size of the touch screen device is limited, there is a limitation in that the touch screen device 100 includes the play bar 210 region having a limited size. For example, in a tablet PC, the touch screen device 100 including the play bar 210 region that is of a straight line of 30 cm or more may cause an inconvenience of a user. A length of a play bar region may be enlarged by arranging the play bar region in a snail-shaped curve or a E-shape (or an S-shape) on the touch screen, but a play bar 210 that is of a straight line may be suitable for providing an intuitive UI to a user.

Therefore, a user manipulating the play bar 210 region having a limited length to select a reproduction time of content may cause an inaccurate selection result to a user. In order to solve such a problem, a multi-touch method based on a pinch to zoom may be used in order for a user to select an accurate reproduction time.

The pinch to zoom is generally known as that a user controls enlarging or reducing of an image in a user interaction, but enables a user to easily select a reproduction time by allowing the user to enlarge or reduce a time line of a play bar 210 of content displayed on a touch screen to be consistent with enlarging or reducing of an image.

As illustrated in FIGS. 8 part (a) and 8 part (b), an image object 225 or 226 representing a pinch to zoom function may be displayed near the play bar 210 region of the user in a time line of the play bar 210 displayed on the touch screen. Herewith, text information informing the user that the play bar 210 region is able to be enlarged may be displayed, such as “enlargement possible” or “enlarge this portion”, for example.

When a touch input of the play bar 210 region using two fingers is received through the touch screen, the input unit 120 of the touch screen device 100 may distinguish a multi-touch from a touch. Also, in the multi-touch, the control unit 130 of the touch screen device 100 may measure a distance between two touch regions and may determine an enlargement rate of a pinch to zoom multi-touch.

When a user input received through the play bar 210 region is a pinch to zoom input, the touch screen device may determine control information that allows the play bar 210 region for a reproduction section of content, corresponding to the pinch to zoom input, to be enlarged and displayed and allows the content to be reproduced at a reproduction speed corresponding to an enlargement rate of the pinch to zoom.

That is, the above-described pinch to zoom input may be used as a control command for a reproduction speed of content, in addition to a function of enlarging and displaying a time line. When a content reproduction command is received from the user in a state of enlarging the time line of the play bar 210, the content may be quickly (or slowly) reproduced based on an enlarged rate. For example, when a pinch to zoom input for enlarging the time line of the play bar 210 by three times is received from the user, the content may be reproduced at ⅓ times a reproduction speed, and thus, an effect such as a slow motion is obtained. On the other hand, when a pinch to zoom input for reducing the time line of the play bar 210 by half is received from the user, the content may be quickly reproduced at two times a reproduction speed.

Hereinabove, a method of determining control information about reproduction of content has been described. Hereinafter, a method of determining control information about editing of content will be described. A user may control reproduction of content and may also edit the content. In the related art, a user restrictively manipulates content like play and pause. Also, in editing content, it is impossible to display an intuitive function to a user. In order to solve such a problem, an intuitive and easy editing method is needed.

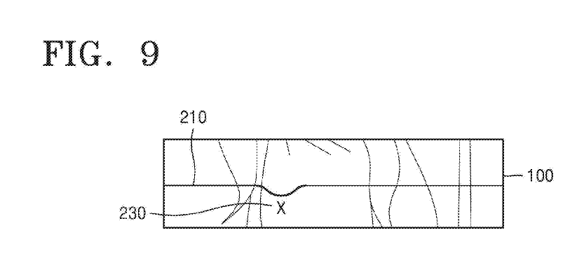

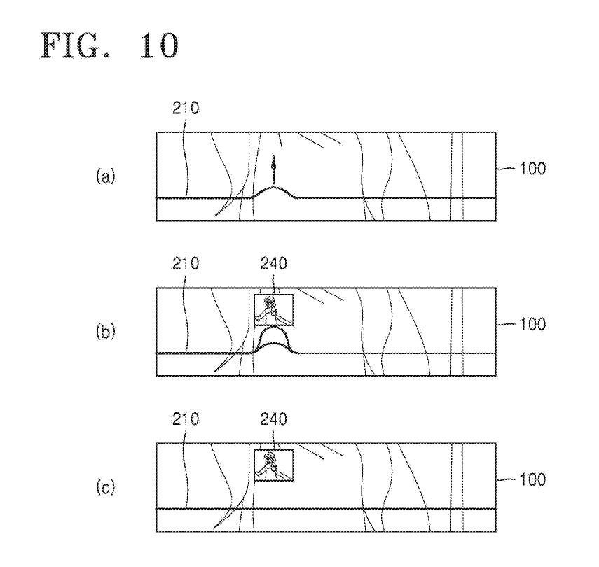

FIG. 9 illustrates a play bar region according to an exemplary embodiment.

As described above with reference to FIG. 6, the touch screen device 100 may receive a touch input of a user, which is made for a predetermined time or more, with respect to a play bar 210 region. When a touch input (i.e., the long press input) which is made for a predetermined time or more is received, the touch input may be determined as control information that allows an object, representing information about editing of content, to be displayed on the touch screen. That is, the touch screen device 100 may display an object 230, representing that the content is able to be edited by the user, on the touch screen.

As illustrated in FIG. 9, by displaying an X-shaped object 230 in the play bar 210 region, the touch screen device 100 may represent that the play bar 210 region is differently displayed. The touch screen device 100 may downward convexly display a current reproduction time (i.e., a ridge bar region which is upward convexly displayed in a ridge shape) of the play bar 210, in addition to displaying the X-shaped object 230, thereby informing the user that the content is able to be edited. Alternatively, when a thumbnail image of a corresponding reproduction time is being displayed near a portion where a reproduction time is displayed, the touch screen device 100 may display the thumbnail image to be shaken like vibrating, thereby representing that the content is able to be edited.

In the disclosure, content editing control may denote a function of extracting or deleting a portion of content executed by the touch screen device 100. However, the present exemplary embodiment is not limited to only two functions, and it may be understood that the content editing control includes a function of repeatedly inserting content or changing a reproduction order.

An object representing that the content is able to be edited may be displayed, and then, the touch screen device 100 may receive a user input for selecting an editing target section of the content through the play bar 210 region. Subsequently, the touch screen device 100 may receive a user input for controlling the editing target section of the content and may edit the content, based on received information about editing of the content. This will be described below in detail.

The user may select the editing target section for editing the content. Because the content is in an editable state, the display unit 110 of the touch screen device 100 may display information, which allows the editing target section to be selected, on the touch screen. The input unit 120 of the touch screen device 100 may receive a touch input, which selects a desired editing target section, through the play bar 210 region from the user. The input unit 120 may receive an input which is made by touching a start time and an end time of the editing target section once each, or may receive a touch input which is made by simultaneously multi-touching two times. When a touch input for one time selected from the start time and the end time is received, the other time may be automatically selected. Because it is possible to change the selected editing target section, the user may change the start time or the end time even after the editing target section is selected, thereby selecting an accurate editing target section. It may be understood by one of ordinary skill in the art that the play bar 210 region is enlarged by using a pinch to zoom interaction, and then, an editing target section is selected.

When the long press input is received through a partial region of the play bar 210 region so as to change a current state to a content-editable state, a portion of the content corresponding to a corresponding region may be immediately selected. For example, by dividing the content into portions of a one-minute length, a portion of content of a one-minute length corresponding to a press touch region made by the user may be selected. When a total time length of the content is long, an inaccurate selection may be performed, but editing may be quickly performed.

The display unit 100 of the touch screen device 100 may display an editing section, selected by the user, on the touch screen. The touch screen device 100 may receive, from the user, a user input for controlling editing of the content for the selected editing section to control editing of the content. Because the play bar 210 region is arranged in a horizontal direction, the touch screen device 100 may receive an input, which is made by dragging a predetermined region to an upper end or a lower end of the play bar 210 region, from the user to perform an editing function.

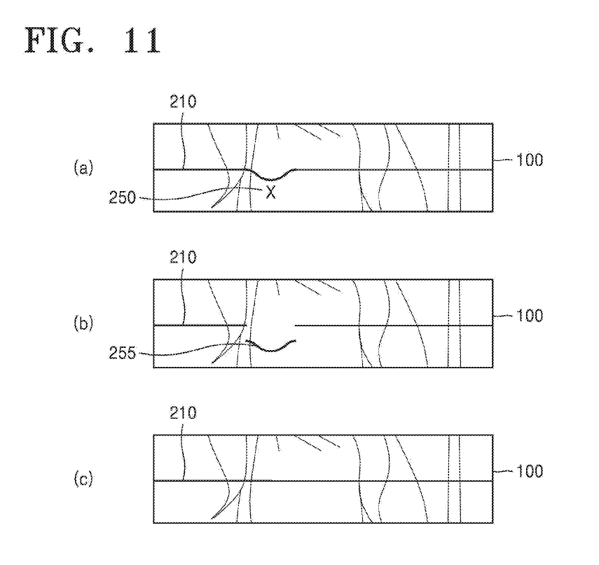

FIG. 10 illustrates an editing screen of content according to an exemplary embodiment.

As illustrated in FIG. 10 part (a), the touch screen device 100 may receive an input which is made by dragging a partial region of the play bar 210 region corresponding to an editing target section in a first direction and may extract, as separate content, a portion of content corresponding to the editing target section, based on the first-direction drag input.

For example, when an input which selects a section from one minute to two minutes of video having a reproduction time of three minutes is received from the user and an up drag input is received, this may be determined as an interaction for extracting and storing a portion of the content, corresponding to a selected time section, as separate content, and the touch screen device 100 may store the separate content.

As illustrated in FIG. 10 part (b), the touch screen device 100 may display, on the touch screen, that a portion of the content corresponding to an editing target section selected by a drag interaction is to be extracted. In order to prevent a malfunction from being caused by the user, the touch screen device 100 may allow the user to cancel a corresponding drag motion by displaying that extraction is to be performed, thereby preventing unnecessary extraction from being performed. A thumbnail image 240 of a portion of the content corresponding to the selected editing target section may be displayed on the touch screen.

As illustrated in FIG. 10 part (c), extracted content may be generated and displayed as a separate clip, and the separate clip may be inserted by dragging the separate clip to a predetermined region of the play bar 210.

FIG. 11 illustrates an editing screen of content according to an exemplary embodiment.

As illustrated in FIG. 11 part (a), when a touch input that selects an editing target section is received through a play bar 210 region from a user, the touch screen device 100 may display the selected editing target section on the touch screen. When an input which is made by dragging a corresponding section in a predetermined direction in the play bar 210 region is received from the user, the touch screen device 100 may edit content, based on the received drag input.

For example, when an input which selects a section from one minute to two minutes of video having a reproduction time of three minutes is received from the user and a down drag input is received, this may be determined as an interaction 250 for deleting a selected editing target section, and the touch screen device 100 may delete the selected editing target section.

As illustrated in FIG. 11 part (b), the touch screen device 100 may display, on the touch screen, that an editing target section selected by a drag interaction 255 is to be deleted. In order to prevent a malfunction from being caused by the user, the touch screen device 100 may allow the user to cancel a corresponding drag motion by displaying that deletion is to be performed, thereby preventing unnecessary deletion from being performed. A thumbnail image 240 of a portion of the content corresponding to the selected editing target section may be displayed on the touch screen.

As illustrated in FIG. 11 part (c), when the selected editing target section is dragged at a predetermined level or more and thus deleted, a previous section and a next section of the deleted editing target section may be successively displayed on a time line of the play bar 210. As in the above-described example, when a portion from one minute to two minutes of video content having a length of total three minutes is deleted, a one-minute time and a two-minute time may be successively displayed, and reproduction may be successively performed.

As described above, it may be seen that reproduction or editing of content which is being displayed is controlled by using a touch input of a user with respect to the play bar 210 region displayed on the touch screen. The touch screen device 100, such as a smartphone, a tablet PC, or the like, may directly receive a touch input for the touch screen to perform the operations, but in a case where the display unit 110 and the input unit 120 are distinguished from each other, a necessary user interaction are more various and complicated.

A remote control apparatus (or a remote controller) may be an apparatus applied to the remote control of an electronic device (a multimedia device) such as a TV, a radio, an audio device, and/or the like. The remote control apparatus (or the remote controller) may be implemented as a wired type or a wireless type. Wireless remote control apparatuses are much used, but in a case where a size of an electronic device itself corresponding to a body of a remote control apparatus is large, because it is also convenient to carry a wired remote control apparatus, the wired remote control apparatus may be used. Because general remote control apparatuses are equipped with some function keys (for example, the number of channels, a volume key, a power key, etc.), an electronic device may be controlled by manipulating the function keys. As electronic devices are equipped with multiple functions, various inputs may be applied to a remote control apparatus that controls the electronic devices. Therefore, in some remote control apparatuses, a more number of key buttons are added, a density of key buttons increases, a function of a key button is overloaded, or a complicated menu system is used, for implementing various inputs.

In some remote control apparatuses, a more number of key buttons are added, a density of key buttons increases, a function of a key button is overloaded, or a complicated menu system is used, for implementing various inputs. However, a UI of a remote control apparatus of the related art depends on a very number of key buttons, which are used in a narrow space of the remote control apparatus, or a complicated key input order and menu system which are memorized by a user.

Recently, a remote control apparatus with a built-in touch pad is applied to various fields. In detail, a method of across touching a tangible region protruding onto the touch pad is used, or a method is used where a control signal is generated by a motion of rubbing the touch pad in up, down, left, and right directions and is transmitted to a body of a multimedia device such as a TV or the like. However, in such a method, it is difficult to simultaneously perform a scroll operation, which is performed on a touch pad of a remote control apparatus, and a manipulation operation of touching a predetermined region of a touch pad with a finger. Therefore, it is required to develop a method of consistently providing a content UI to a user interaction and a GUI by performing both a scroll operation and a touch operation.

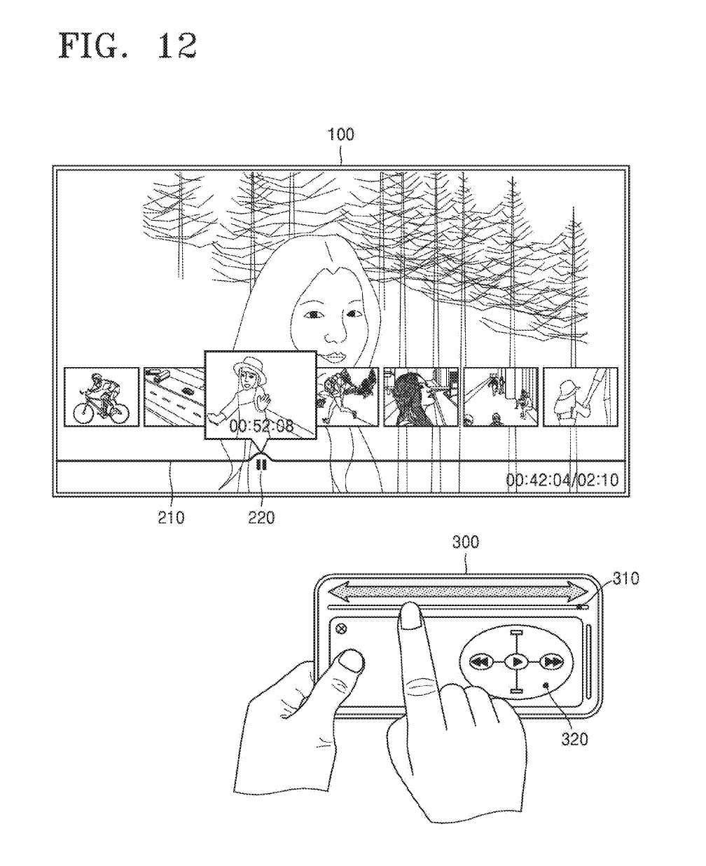

FIG. 12 illustrates a screen for controlling content by using a remote control apparatus according to an exemplary embodiment.

In the following description, it is assumed that content is displayed in an electronic device and a separate remote control apparatus distinguished from the electronic device is provided. In the disclosure, the electronic device may denote a device that displays an image, video, or a sound and may be understood as a concept including the above-described touch screen device 100. The touch screen device 100 may include the display unit 110 and the input unit 120 that receives a user input. On the other hand, an electronic device 300 may include a display unit 330, but because there is a case where the electronic device 300 cannot receive a user input, the electronic device 300 may be construed as a broader meaning than that of the touch screen device 100.

As described above with reference to FIGS. 1 to 11, a touch bar may be included in a remote control apparatus, and content may be controlled by a method corresponding to a touch input with respect to a play bar 210 region.

As illustrated in FIG. 12, the touch screen device 100 may display the play bar 210 when a touch input is received from a user in the middle of reproducing content. Also, the touch screen device 100 may display a ridge bar which represents a current reproduction time and is upward convexly displayed in a ridge shape, thereby providing the user with current reproduction progress information of the content.

The touch screen device 100 may display an object, representing a function associated with reproduction of the content, near a reproduction time of the play bar 210 region to provide the user with information about a controllable function for the content.

The remote control apparatus may receive a touch input of the user for the remote control apparatus and transmit a content control-related signal to the electronic device 300. A detailed method of controlling content will be described below.

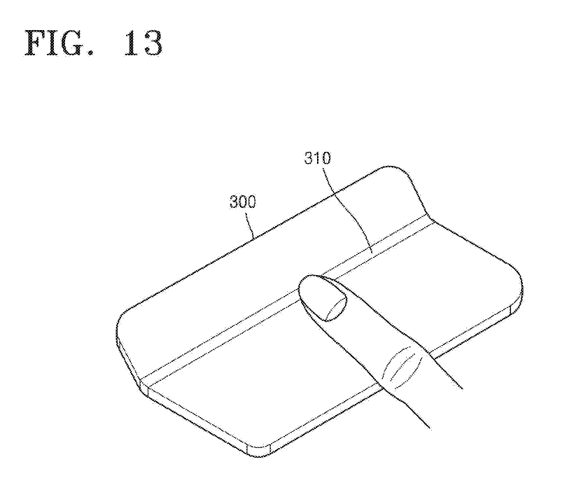

FIG. 13 illustrates a remote control apparatus 300 according to an exemplary embodiment.

As illustrated in FIG. 13, the remote control apparatus 300 may include a bent structure. The remote control apparatus 300 may include a touch bar region 310 provided in a region which is long grooved due to the bent structure.

The remote control apparatus 300 may include the touch bar region 310 and may also include a separate touch screen region or button input region 320 in addition to the touch bar region 310.

The touch bar described herein may include a boundary portion which is long arranged in a horizontal direction along a bent portion, but may not denote only a bent boundary portion in terms of receiving a touch input of a user. In the disclosure, the touch bar may be understood as including a region for receiving the touch input of the user, and thus may include a partial region of an upper end and a partial region of a lower end which are disposed with respect to the boundary portion. Hereinafter, the touch bar and the touch bar region may be all used.

Because the touch bar region 310 is a region for receiving the user input of the user, the touch bar region 310 may be provided in a tangible bar form protruding onto a predetermined plane so as to realize an easier touch input, but in contrast, the touch bar region 310 may be provided in a grooved bar form. It has been described above that a predetermined portion of the remote control apparatus 300 is provided in the bent structure, and a boundary portion having the bent structure is provided as the touch bar region 310. The touch bar may protrude onto a plane or is grooved without including the bent structure. However, the touch input of the user may be made at a bent boundary portion in order for the user to perform more intuitive and easy manipulation.

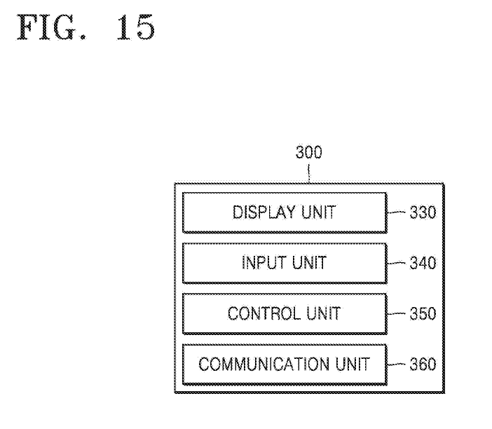

The touch input of the user being received through the bent boundary portion is good in sight and tactility. The bent boundary portion may be provided to be grooved in structure, and the user may scroll or touch the grooved touch bar region 310 to provide a user input (for example, a finger touch input). There may be various kinds of touches, and examples of touches may include a short touch, a long press touch which is made by touching one region for a predetermined time or more, and a multi-touch such as a pinch to zoom. When a proximity sensor is included in a touch bar, a proximity touch may be realized. The proximity touch may denote a touch method where a touch input unit 340 (see FIG. 15) is not physically touched, but when a motion is made at a position which is separated from the touch input unit 340 by a predetermined distance, the touch input unit 340 electrically, magnetically, or electromagnetically senses the motion to receive the motion as an input signal.

The touch bar region 310 may be displayed through a GUI displayed on the touch screen in a touch screen region without the touch screen region being distinguished from the touch bar region 310. The remote control apparatus 300 may be divided into an upper end and a lower end with respect to a bent boundary, and each of the upper end and the lower end may be a region for receiving the touch input of the user.

When the touch bar region 310 is scrolled with a touch pen such as a stylus pen or the like, the touch pen is easily moved in a lateral direction in the bent boundary portion as if drawing a straight line with a ruler, and thus, the touch bar region 310 is quickly and accurately scrolled.

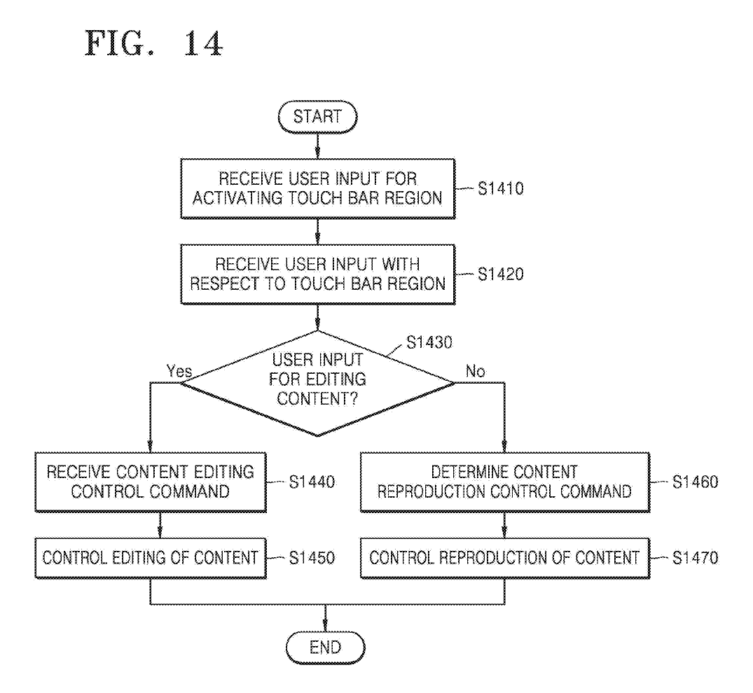

FIG. 14 is a diagram illustrating an operation of controlling content by using a remote control apparatus according to an exemplary embodiment.

In operation S1410, the remote control apparatus 300 may receive a user input for activating a touch bar region. The remote control apparatus 300 may receive, from the user, a touch input which is made by touching or gripping the remote control apparatus 300. When a touch having a predetermined pattern or a grip input is received by an input unit 340 (see FIG. 15), a control unit 350 (see FIG. 15) of the remote control apparatus 300 may determine that a user input for activating the touch bar region 310 is received. The touch having the predetermined pattern may denote a series of touch array having a predetermined sequence. The grip input may denote a touch input, which is made for the input unit 340 by gripping the remote control apparatus 300, or an input where the remote control apparatus 300 being gripped by the user is sensed by a sensor of the remote control apparatus 300.

In the disclosure, activation of the touch bar region 310 may denote activation which is performed for recognizing a touch input physically applied to the input unit 340 of the remote control apparatus 300. Alternatively, the activation of the touch bar region 310 may denote that in a state where a touch input of a user is always receivable, the remote control apparatus 300 receives a user input for controlling the electronic device 300 and activates a function of controlling the electronic device 300 in response to the user input.

The control unit 350 of the remote control apparatus 300 may determine a touch input, which is applied through the touch screen region or the touch bar region 310 of the remote control apparatus 300, as a user input for activating the touch bar region 310. The control unit 350 may determine, as an activation input with respect to the touch bar region 310, touching, proximity-touching, or gripping of the touch bar region 310 of the remote control apparatus 300. When the touch bar region 310 is activated, the remote control apparatus 300 may inform the user that a touch input is able to be made. For example, the remote control apparatus 300 may adjust a screen brightness of a touch screen, vibrate, or output a sound to inform the user that the remote control apparatus 300 is able to be manipulated. Likewise, the electronic device 300 may inform the user that a touch input is able to be made. In the disclosure, when the touch bar region 310 of the remote control apparatus 300 is activated, a function of enabling the user to control the content may be displayed on a screen of the electronic device 300, thereby helping the user control the content.

In operation S1420, the input unit 340 of the remote control apparatus 300 may receive a touch input of the user with respect to the touch bar region 310. Because the touch input is a user input for controlling the content, the remote control apparatus 300 may determine whether the touch input is for controlling reproduction of the content or editing of the content.

In operation S1430, the control unit 350 may determine an of the touch input of the user with respect to the touch bar region 310 to determine whether the touch input is a user input for editing the content. For example, when the user touches (long press) a partial region of the touch bar region 310 for a predetermined time or more, the control unit 350 may determine whether to enter an editing mode for the content. Switching to the editing mode for the content may denote that the content is in an editable state, and may be construed as a broad meaning. Switching to the editing mode for the content is not limited to the long press input and may be performed in various user input forms.

The remote control apparatus 300 that has determined the long press input as being received from the user may transmit a signal of the received touch input to the electronic device 300. The electronic device 300 that has received a user input signal from the remote control apparatus 300 may switch to the editing mode for the content. The electronic device 300 may display an object, which indicates switching to the editing mode, on a screen. Here, the object may be a text or an image.

In operation S1440, after the electronic device 300 switches to the editing mode for the content, the remote control apparatus 300 may receive, from the user, a touch input (a content editing control command) for editing the content.

In operation S1450, the remote control apparatus 300 may convert the touch input of the user, which edits the content, into a signal and transmit the converted signal to the electronic device 300. The electronic device 300 receiving the signal may edit the content, based on the received signal.

In operation S1460, in contrast with operation S1440, when the touch input of the user received through the touch bar region 310 is not the long press input, namely, when a partial region of the touch bar region 310 is touched for less than a predetermined time (for example, a short touch), the partial region and the other region are touched (for example, a drag input), or a multi-touch such as a pinch to zoom is received, the remote control apparatus 300 may determine the received touch input as a touch input for controlling reproduction of the content. For example, in a case where switching to the editing mode for the content is set to be performed when the long press input which is made by touching a partial region of the touch bar region 310 for 1.5 seconds or more is received, when the user touches a partial region of the touch bar region 310 for one second, the remote control apparatus 300 may determine a corresponding input as a content reproduction control command such as play or pause. In the disclosure, a case where a received input is determined as a touch input for a reproduction control command may be referred to as a reproduction control mode. The reproduction control mode may denote that the content is in a reproduction-controllable state and may be construed as a broad meaning.

In operation S1470, the remote control apparatus 300 may convert the touch input of the user into a signal and transmit the converted signal to the electronic device 300. The electronic device 300 receiving the signal may control reproduction of the content, based on the received signal.

FIG. 15 is a block diagram illustrating a remote control apparatus 300 according to an exemplary embodiment.

The remote control apparatus 300 may include a display unit 330, an input unit 340, a control unit 350, and a communication unit 360. An appearance of the remote control apparatus 300 does not limit the present embodiment.

The display unit 330 may include an image panel such as a liquid crystal panel, an organic light-emitting panel, or the like and may display graphic of a UI which represents a function setting, a software application, or content (hereinafter referred to as a manipulation menu) such as music, a photograph, video, and/or the like.

The input unit 340 may receive a user input for controlling the electronic device 300.

The input unit 340 may receive a touch input of a user through a touch screen built into the remote control apparatus 300, or because the remote control apparatus 300 includes a built-in hardware button, the input unit 340 may receive a button input. An input received through the touch screen may be a concept including an input received through the above-described touch bar, and may be construed as a concept including a pen touch and a proximity touch.

The control unit 350 may decode data input through the input unit 340. The control unit 350 may decode a user input received through the input unit 340 to convert the user input into a signal receivable by the electronic device 300 controlled by the remote control apparatus 300.

The communication unit 360 may transmit a control command to the electronic device 300. The communication unit 360 may use a well-known communication module such as an infrared communication module, a radio communication module, an optical communication module, and/or the like. For example, the infrared communication module satisfying an infrared data association (IrDA) protocol that is the infrared communication standard may be used as the communication unit 360. As an example, a communication module using a frequency of 2.4 GHz or a communication module using Bluetooth may be used as the communication unit 360.

Reproduction or editing of content is intuitively controlled by manipulating a touch bar, and particularly, time-based manipulation of the content is easily performed.

However, the present embodiment is not limited thereto, and manipulation of the touch bar may be variously applied without being limited to manipulation which is performed on a time line of the touch bar. Because a touch region is provided in a long bar form, it is possible to change a setting value of content depending on relative left and right positions.

For example, a left boundary value of the touch bar may be a minimum value of content volume, and a right boundary value of the touch bar may be a maximum value of the content volume. Therefore, the touch bar may be used for adjusting volume. In content that provides a stereo sound, the touch bar may be used for adjusting a balance of a left sound and a right sound.

As an example, the touch bar may be used for adjusting brightness or a sense of color of content. Because the touch bar is an input unit having a length, the touch bar may be used for adjusting a series of values and enables quick manipulation to be performed by manipulating a +/−key of the touch screen.

The inventive concept may also be embodied as processor readable codes on a processor readable recording medium included in a digital device such as a central processing unit (CPU). The computer readable recording medium is any data storage device that may store data which may be thereafter read by a computer system.

Examples of the computer-readable recording medium include read-only memory (ROM), random-access memory (RAM), CD-ROMs, magnetic tapes, floppy disks, and optical data storage devices. The computer readable recording medium may also be distributed over network coupled computer systems so that the computer readable code may be stored and executed in a distributed fashion. Also, functional programs, codes, and code segments for implementing the method of providing a GUI may be easily construed by programmers of ordinary skill in the art to which the inventive concept pertains.

As described above, the touch screen device and the control system and method using the same according to the exemplary embodiments enable a user to intuitively and easily control the reproduction or editing of content displayed on a touch screen. It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A content control method performed by a touch screen apparatus, the content control method comprising:
displaying a play bar region, representing a reproduction state of content being reproduced by the touch screen apparatus, on a touch screen of the touch screen apparatus;
displaying an object, representing a function associated with the reproduction of the content, near a reproduction time of the play bar region;
receiving, through the touch screen, a user input to the play bar region;
determining control information about the content, based on the received user input; and
controlling the reproduction of the content according to the determined control information.

2. The content control method of claim 1, wherein the function associated with the reproduction of the content comprises at least one of whether to reproduce the content, a reproduction speed, and an additional reproduction function.

3. The content control method of claim 2, wherein the additional reproduction function comprises at least one of a screen brightness adjustment function, a sound adjustment function, and a chroma adjustment function for the content.

4. The content control method of claim 1, wherein the control information about the content comprises at least one of control information about reproduction of the content and control information about editing of the content.

5. The content control method of claim 4, wherein the object representing a function associated with the reproduction of the content comprises at least one of a text object and an image object.

6. The content control method of claim 1, wherein the displaying of the object comprises displaying the object when at least one of a touch input of a user, a proximity touch input, and a voice input is received by the touch screen apparatus.

7. The content control method of claim 1, wherein the determining of the control information comprises, when the user input received through the play bar region is a touch input with respect to a partial region of the play bar region corresponding to a current reproduction time of the content, determining control information for playing or pausing the content.

8. The content control method of claim 1, wherein the determining of the control information comprises, when the user input received through the play bar region is a touch input with respect to a partial region of the play bar region which does not correspond to a current reproduction time of the content, determining control information for displaying a portion of the content, corresponding to a reproduction time which corresponds to a partial region of the play bar region where the touch input is received, on the touch screen.

9. The content control method of claim 1, wherein the determining of the control information comprises, when the user input received through the play bar region is a pinch to zoom input, determining control information that allows the play bar region for a reproduction section of the content, corresponding to the pinch to zoom input, to be enlarged and displayed and allows the content to be reproduced at a reproduction speed corresponding to an enlargement rate of the pinch to zoom.

10. The content control method of claim 1, wherein the determining of the control information comprises, when the user input received through the play bar region is a touch input which is made by touching a predetermined region for a predetermined time or more, determining control information that allows an object, representing information about editing of the content, to be displayed.

11. The content control method of claim 10, further comprising:
receiving a user input for selecting an editing target section of the content through the play bar region; and
receiving a user input for controlling the editing target section of the content.

12. The content control method of claim 11, wherein the receiving of the user input for controlling the editing target section comprises:
receiving an input which is made by dragging a partial region of the play bar region, corresponding to the editing target section, in a first direction; and
extracting, as separate content, a portion of the content corresponding to the editing target section, based on the first-direction drag input.

13. The content control method of claim 11, wherein the receiving of the user input for controlling the editing target section comprises:
receiving an input which is made by dragging a partial region of the play bar region, corresponding to the editing target section, in a second direction; and
deleting the editing target section from the content, based on the second-direction drag input.

14. A touch screen apparatus for controlling content, the touch screen apparatus comprising:
a display configured to display a play bar region, representing a reproduction state of content being reproduced by the touch screen apparatus, on a touch screen of the touch screen apparatus and display an object, representing a function associated with the reproduction of the content, near a reproduction time of the play bar region;
an input configured to receive a user input to the play bar region; and
a controller configured to determine control information about the content, based on the received user input, and control the reproduction of the content according to the determined control information.

15. A non-transitory computer-readable recording medium having embodied thereon a program to implement the method of claim 1.

16. An apparatus comprising:
a display configured to display content and a control bar to enable control of a reproduction of the content on the display of the apparatus;
an input configured to receive a multi-touch user input to the control bar; and
a controller configured to control the reproduction of the content based on the received multi-touch user input.

17. The apparatus of claim 16, wherein the multi-touch user input is a pinch to zoom input.
